(19) United States
(12) Patent Application Publication
(10) Pub. No.: US 2024/0000079 A1
(43) Pub. Date: Jan. 4, 2024

(54) LIQUID PESTICIDAL COMPOSITION

(71) Applicant: SUMITOMO CHEMICAL COMPANY, LIMITED, Chuo-ku (JP)

(72) Inventor: Takuya TANAKA, Chuo-ku (JP)

(73) Assignee: SUMITOMO CHEMICAL COMPANY, LIMITED, Chuo-ku (JP)

(21) Appl. No.: 18/254,828

(22) PCT Filed: Nov. 30, 2021
(86) PCT No.: PCT/JP2021/043746

§ 371 Date: May 26, 2023

(30) Foreign Application Priority Data
Dec. 1, 2020 (JP) 2020-199848

(51) Int. Cl. A01N 43/54; A01N 25/02; A01N 25/30

(52) U.S. Cl. CPC A01N 43/54; A01N 25/02; A01N 25/30

(57) ABSTRACT

Provided is a liquid pesticidal composition having good storage stability at low temperatures. The liquid pesticidal composition comprises (a) a compound represented by the formula (I), (b) a solvent having a water solubility at 25° C. of 10 mass % or less, (c) a surfactant, and (d) 0.04 mass % or more and 3.30 mass % or less of water.

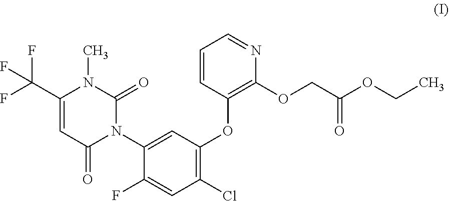 [SMILES: CCOC(=O)COc1ncccc1Oc1cc(-n2c(=O)cc(C(F)(F)F)n(C)c2=O)c(F)cc1Cl]

### TECHNICAL FIELD

The present invention relates to a liquid pesticidal composition.

### BACKGROUND ART

U.S. Pat. No. 6,537,948 (Patent Literature 1) describes a compound represented by the formula (I):

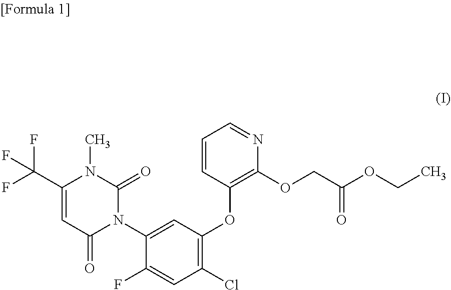 [SMILES: CCOC(=O)COc1ncccc1Oc1cc(-n2c(=O)cc(C(F)(F)F)n(C)c2=O)c(F)cc1Cl]

as an active ingredient for herbicides.

### CITATION LIST

### Patent Literature

PTL 1: U.S. Pat. No. 6,537,948

### SUMMARY OF INVENTION

### Technical Problem

An object of the present invention is to provide a liquid pesticidal composition comprising a compound represented by the formula (I), wherein the liquid pesticidal composition has good storage stability at low temperatures.

### Solution to Problem

The present invention provides the following liquid pesticidal composition.

[1] A liquid pesticidal composition comprising
(a) a compound represented by the formula (I):

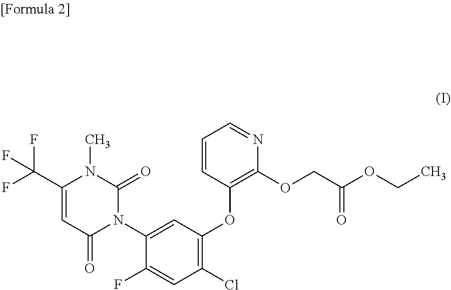 [SMILES: CCOC(=O)COc1ncccc1Oc1cc(-n2c(=O)cc(C(F)(F)F)n(C)c2=O)c(F)cc1Cl]

(b) a solvent having a water solubility at 25° C. of 10 mass % or less,
(c) a surfactant, and
(d) 0.04 mass % or more and 3.30 mass % or less of water.

[2] The liquid pesticidal composition according to [1], wherein the solvent comprises an aromatic hydrocarbon.

[3] The liquid pesticidal composition according to [1] or [2], wherein the surfactant comprises one or more surfactants selected from the group consisting of anionic surfactants and nonionic surfactants.

[4] The liquid pesticidal composition according to any one of [1] to [3], wherein a content of the water is 0.05 mass % or more and 3.14 mass % or less.

### Advantageous Effects of Invention

According to the present invention, it is made possible to provide a liquid pesticidal composition comprising a compound represented by the formula (I), wherein the liquid pesticidal composition prevents the occurrence of precipitation or deposits when stored in a low-temperature environment and has good storage stability.

### DESCRIPTION OF EMBODIMENTS

A liquid pesticidal composition according to the present invention (hereinafter, also simply called “liquid pesticidal composition”) comprises
(a) a compound represented by the formula (I):

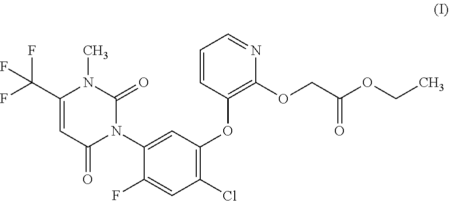 [SMILES: CCOC(=O)COc1ncccc1Oc1cc(-n2c(=O)cc(C(F)(F)F)n(C)c2=O)c(F)cc1Cl]

(hereinafter, also called “compound (I)”)
(b) a solvent having a water solubility at 25° C. of 10 mass % or less,
(c) a surfactant, and
(d) 0.04 mass % or more and 3.30 mass % or less of water.

The term “liquid” herein refers to being flowable at 25° C. Preferably, the liquid pesticidal composition is a liquid in which at least the pesticidal active ingredient, among its ingredients, is completely or nearly completely dissolved in the solvent. More preferably, the liquid pesticidal composition is a liquid in which at least the pesticidal active ingredient, the surfactant and water, among its ingredients, are completely or nearly completely dissolved in the solvent. Further preferably, the liquid pesticidal composition is a liquid in which all of its ingredients are completely or nearly completely dissolved in the solvent.

According to the present invention, it is made possible to provide a liquid pesticidal composition having good storage stability at low temperatures. Examples of the temperature conditions of storage at low temperatures include storage in an environment at 0° C. or lower, storage in an environment at −10° C. or lower, and storage in an environment at −20° C. or lower. Examples of the storage period at low temperatures include storage for 1 day or longer, storage for 1 week or longer, storage for 1 month or longer, storage for 1 year or longer, and storage for 2 years or longer.

In the following, a detailed description will be given of ingredients that the liquid pesticidal composition according to the present invention contains or may contain.

(a) Compound (I)

The liquid pesticidal composition contains a compound (I) as a pesticidal active ingredient. The compound (I) is a known compound and is represented by the formula (I) given below. The compound (I) can be produced by a known method such as a method described in U.S. Pat. No. 6,537,948.

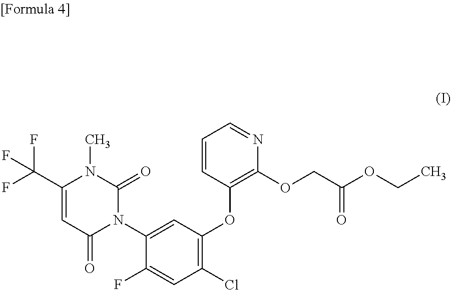 [SMILES: CCOC(=O)COc1ncccc1Oc1cc(-n2c(=O)cc(C(F)(F)F)n(C)c2=O)c(F)cc1Cl]

With the total amount of the liquid pesticidal composition being taken as 100 mass %, the content of the compound (I) in the liquid pesticidal composition is generally 0.1 mass % or more and 50 mass % or less, preferably 0.5 mass % or more and mass % or less, more preferably 1 mass % or more and 30 mass % or less, further preferably 2 mass % or more and 25 mass % or less, yet further preferably 3 mass % or more and 20 mass % or less. Other preferable ranges of the content are, for example, 3 mass % or more and 12 mass % or less, 3 mass % or more and 10 mass % or less, 4 mass % or more and 15 mass % or less, 4 mass % or more and 12 mass % or less, and 5 mass % or more and 10 mass % or less.

(b) Solvent

The liquid pesticidal composition contains one, two, or more solvents having a water solubility at 25° C. of 10 mass % or less (hereinafter, also called “hydrophobic solvent”).

Examples of the hydrophobic solvent include:
alcohols such as butanol, amyl alcohol, hexanol, heptanol, octanol, 2-ethylhexanol, cyclohexanol and benzyl alcohol;
esters such as acetic acid esters (e.g., ethyl acetate, butyl acetate, isoamyl acetate, isobornyl acetate, hexyl acetate, heptyl acetate, octyl acetate, and benzyl acetate), carbonic acid esters (e.g., diethyl carbonate and dibutyl carbonate), fatty acid esters (e.g., isopropyl myristate, methyl octanoate, methyl oleate, methyl laurate, dimethyl adipate, dibutyl adipate, didecyl adipate, tri-n-butyl citrate, di-n-butyl phthalate, methyl caprylate, methyl laurate, methyl myristate, methyl salicylate, methyl palmitate, methyl oleate, and ethyl palmitate), phthalic acid esters (e.g., dimethyl phthalate and diethyl phthalate), benzoic acid esters (e.g., methyl benzoate and ethyl benzoate), succinic acid esters (e.g., dioctyl succinate), and acetoacetic acid esters (e.g., tert-butyl acetoacetate and allyl acetoacetate);
ethers such as propylene glycol phenyl ether;
ketones such as cyclohexanone, 2-heptanone, isophorone, mesityl oxide, methyl isoamyl ketone, methyl isobutyl ketone, methylcyclohexanone, and acetophenone;
amides such as fatty acid dimethylamides (e.g., N,N-dimethyldecanamide, N,N-dimethyldodecanamide, N,N-dimethyltetradecanamide, and N,N-dimethyloctadecanamide), and alkylpyrrolidones (e.g., N-octyl-pyrrolidone, N-dodecyl-pyrrolidone, and N-decyl-pyrrolidone);
lactones such as γ-octanolactone and δ-octanolactone;
amines such as n-octylamine, oleylamine, and laurylamine;
aliphatic hydrocarbons such as decane, tridecane, tetradecane, hexadecane, octadecane, normal paraffin, isoparaffin, cycloparaffin, 1-undecene and 1-heneicosene;
aromatic hydrocarbons such as alkylbenzenes such as toluene, xylene, ethylbenzene, octadecylbenzene, dialkylbenzene and trialkylbenzene, alkylnaphthalenes such as methylnaphthalene, dimethylnaphthalene, dodecylnaphthalene and tridecylnaphthalene, and phenylxylylethane and 1-phenyl-1-ethylphenylethane, and a mixture of these;
fatty acids such as oleic acid, capric acid, and enanthic acid;
animal- or vegetable-derived oils such as coconut oil, olive oil, soybean oil, rapeseed oil, castor oil, linseed oil, cottonseed oil, palm oil, avocado oil, shark liver oil, sardine oil, and saury oil;
mineral oils such as naphtha, petroleum ether, kerosene, diesel oil, paraffin, olefin, and machine oil; and
silicone oil.

As the hydrophobic solvent, a commercially available solvent may be used. Examples of the commercially available product of the hydrophobic solvent include, in trade names, Hallcomid M-8-10 (mixture of N,N-dimethyloctanamide and N,N-dimethyldecanamide, manufactured by Stepan), Hallcomid M-10 (N,N-dimethyldecanamide, manufactured by Stepan), Hallcomid M-12 (N,N-dimethyldodecanamide, manufactured by Stepan), Hallcomid M-18 (N,N-dimethyloctadecanamide, manufactured by Stepan), Hallcomid 1025 (N,N-dimethyl-9-deceneamide, manufactured by Stepan), Rhodiasolv Iris (mixture of dimethyl 2-methylglutarate, dimethyl 2-ethylsuccinate, and dimethyl adipate, manufactured by Solvay), PURASOLV EHL (2-ethylhexyl-L-lactate, manufactured by Corbion purac), AGSOLEX 8 (N-octyl-pyrrolidone, manufactured by Ashland), AGSOLEX 12 (N-dodecyl-pyrrolidone, manufactured by Ashland), Stepan C-25 (methyl caprylate, manufactured by Stepan), Stepan C-42 (mixture of methyl laurate and methyl myristate, manufactured by Stepan), Stepan C-65 (mixture of methyl palmitate and methyl oleate, manufactured by Stepan), Dowanol PPh (propylene glycol phenyl ether, manufactured by Dow Chemical), Nisseki Hisol SAS-296 (mixture of 1-phenyl-1-xylylethane and 1-phenyl-1-ethylphenylethane, manufactured by JX Nippon Oil & Energy), Aromatic 100 Fluid (containing C9-C10 dialkyl- and trialkylbenzene as its main aromatic hydrocarbon, manufactured by ExxonMobil Chemical), Aromatic 150 Fluid (containing C10-C11 alkyl benzene as its main aromatic hydrocarbon, manufactured by ExxonMobil Chemical), Aromatic 150ND Fluid (containing C10-C11 alkyl benzene as its main aromatic hydrocarbon, manufactured by ExxonMobil Chemical), Aromatic 200 Fluid (containing C10-C13 alkyl naphthalene as its main aromatic hydrocarbon, manufactured by ExxonMobil Chemical), and Aromatic 200ND Fluid (containing C10-C13 alkyl naphthalene as its main aromatic hydrocarbon, manufactured by ExxonMobil Chemical).

For ensuring that the compound (I) is soluble and that the liquid pesticidal composition has good emulsion stability when mixed or diluted with water, the hydrophobic solvent preferably comprises an aromatic hydrocarbon, an aliphatic hydrocarbon, a ketone, an ester, an ether, an amide, an amine, and/or an alcohol, and more preferably comprises an aromatic hydrocarbon. The aromatic hydrocarbon preferably comprises one or more selected from the group consisting of alkylbenzenes such as toluene, xylene, ethylbenzene, octadecylbenzene, dialkylbenzene and trialkylbenzene, alkylnaphthalenes such as methylnaphthalene, dimethylnaphthalene, dodecylnaphthalene and tridecylnaphthalene, and phenylxylylethane and 1-phenyl-1-ethylphenylethane, and a mixture of these, more preferably alkylbenzenes and alkylnaphthalenes, and more preferably comprises one or more selected from the group consisting of C9-C12 alkylbenzenes and C10-C15 alkylnaphthalenes. The hydrophobic solvent may consist of an aromatic hydrocarbon.

The water solubility at 25° C. of the hydrophobic solvent is 10 mass % or less and may be, for example, 8 mass % or less, may be 6 mass % or less, may be 4 mass % or less, may be 2 mass % or less, and may be 1 mass % or less. It is preferable that the liquid pesticidal composition contain the hydrophobic solvent having water solubility within the range because the liquid pesticidal composition easily forms an emulsion when mixed with water. The water solubility at 25° C. of the hydrophobic solvent may be, for example, 0 mass % or more, may be 10⁻⁵ mass % or more, may be 10⁻⁴ mass % or more, and may be 10⁻³ mass % or more. For improving emulsion stability in mixing with water, it is preferable that the liquid pesticidal composition contain the hydrophobic solvent having water solubility within the range.

The water solubility at 25° C. herein refers to the solubility in water at a temperature of 25° C. and pH 7. For example, a water solubility at 25° C. of 1 mass % means that the solubility in 1 g of water at a temperature of 25° C. and pH 7 is 1×10⁻² g.

As the water solubility of the hydrophobic solvent, a value found in the database (Solubility Database) of International Union of Pure and Applied Chemistry (IUPAC) or National Institute of Standards and Technology (NIST) may be used. When a corresponding value is not found in the database, the water solubility of the hydrophobic solvent may be measured by determining the saturation solubility in water at a temperature of 25° C. and pH 7 by high-performance liquid chromatography.

With the total amount of the liquid pesticidal composition being taken as 100 mass %, the content of the hydrophobic solvent in the liquid pesticidal composition is preferably 10 mass % or more and 99 mass % or less, more preferably 20 mass % or more and 95 mass % or less, further preferably 30 mass % or more and 90 mass % or less.

The content of the hydrophobic solvent relative to the content of the compound (I) is usually 5 times by mass or more and 50 times by mass or less, preferably 6 times by mass or more and 40 times by mass or less, more preferably 7 times by mass or more and 30 times by mass or less, further preferably 8 times by mass or more and 25 times by mass or less, yet further preferably 9 times by mass or more and 20 times by mass or less, particularly preferably 10 times by mass or more and 15 times by mass or less. Other preferable ranges of the ratio (mass ratio) of the content of the hydrophobic solvent to the content of the compound (I) are 6 times by mass or more and 25 times by mass or less, 6 times by mass or more and 20 times by mass or less, 6 times by mass or more and 15 times by mass or less, 8 times by mass or more and 20 times by mass or less, 8 times by mass or more and 15 times by mass or less, 10 times by mass or more and 25 times by mass or less, 10 times by mass or more and 20 times by mass or less, and 10 times by mass or more and 15 times by mass or less.

When the liquid pesticidal composition contains two or more hydrophobic solvents, the content of the hydrophobic solvent mentioned above is the total content of the two or more hydrophobic solvents. The same holds true for other ingredients that the liquid pesticidal composition contains or may contain, and the content of each ingredient is the total content of two or more ingredients, if contained, unless otherwise specified.

The liquid pesticidal composition can contain an organic solvent other than the hydrophobic solvent. However, for improving the storage stability and emulsion stability in mixing with water of the liquid pesticidal composition, it is preferable that the organic solvent contained in the pesticidal composition consist of the hydrophobic solvent.

(c) Surfactant

The liquid pesticidal composition contains one, two, or more surfactants. Examples of the surfactant include ionic surfactants and nonionic surfactants. Examples of the ionic surfactant include anionic surfactants, cationic surfactants, and amphoteric surfactants. The surfactant comprises one or more surfactants selected from the group consisting of anionic surfactants and nonionic surfactants.

Examples of the anionic surfactant include:
sulfonates such as alkylsulfonates (e.g., dodecylsulfonate), alpha olefin sulfonates, alkylbenzenesulfonates (e.g., decylbenzenesulfonate, dodecylbenzenesulfonate, tridecylbenzenesulfonate, and diphenylsulfonate), alkylnaphthalenesulfonates (e.g., naphthalenesulfonate, dibutylnaphthalenesulfonate, 2,2′-dinaphthylmethane-6,6′-disulfonate, diisopropylnaphthalenesulfonate, and triisopropylnaphthalenesulfonate), dialkylsulfosuccinates (e.g., sodium di(2-ethylhexyl)sulfosuccinate), N-methyl-N-acyltaurine salts (e.g., methyl oleoyl taurate), other than that, lignin sulfonates, alkylphenolsulfonates and derivatives thereof, naphthalenesulfonate-formaldehyde condensates and derivatives thereof, and benzimidazolesulfonate derivatives;
sulfuric acid ester salts such as alkyl sulfates (e.g., n-hexyl sulfate, n-heptyl sulfate, lauryl sulfate, lauryl sulfuric acid diethanol salt, and octadecyl sulfate), polyoxyethylene alkyl ether sulfates (e.g., laureth-3-sulfate), polyoxypropylene alkyl ether sulfates, and polyoxyethylene distyryl phenyl ether sulfuric acid ester salts;
carboxylates such as fatty acid salts such as octanoate, decanoate, laurate, myristate, palmitate, stearate, behenate, and oleate, and derivatives thereof, ether carboxylates such as laureth-3-carboxylate, and derivatives thereof, N-acylsarcosine salts such as N-lauroylsarcosine salt, and derivatives thereof, N-acylglutamates such as N-lauroylglutamate, and derivatives thereof, polyacrylates, polyvinyl acetates, and polycarboxylates such as comb-shaped polymers of polyacid salts, and derivatives thereof; and
phosphoric acid ester salts such as alkyl phosphates such as lauryl phosphate, and derivatives thereof, polyoxyethylene alkyl ether phosphates and derivatives thereof, polyoxyethylene alkyl phenyl ether phosphates and derivatives thereof, and polyoxypropylene alkyl ether phosphates and derivatives thereof.

Examples of the salt in the sulfonates, the sulfuric acid ester salts, the carboxylates, and the phosphoric acid ester salts include sodium salts, potassium salts, calcium salts, ammonium salts, isopropylamine salts, and triethanolamine salts.

Examples of the cationic surfactant include:
alkylamine salts such as monomethylamine salts, dimethylamine salts, trimethylamine salts, and dodecylamine salts;
fatty acid amide amine salts such as stearamide propyldimethylamine and behenamide propyldimethylamine;
polyamine salts such as polyvinylamine and polyethyleneimine; and
alkyl quaternary ammonium salts such as lauryltrimethylammonium salt, cetyltrimethylammonium salt, dodecyltrimethylammonium salts, stearylmethylammonium salts, ethylammonium benzylbis(2-chloroethyl)bromide salts, alkyldimethylbenzylammonium salts, alkylpyridinium salts, alkylisoquinolinium salts and dialkylmorpholinium salts.

As an ionic surfactant, a commercially available ionic surfactant may be used.

Examples of the commercially available anionic surfactant include, in trade names, Rhodacal 70 (calcium dodecylbenzenesulfonate, branched, manufactured by Solvay), Rhodacal 70/B (calcium dodecylbenzenesulfonate, linear, manufactured by Solvay), Rhodacal LDS-25/AP (sodium dodecylbenzenesulfonate, linear, manufactured by Solvay), Calsogen 4814 (calcium dodecylbenzenesulfonate, manufactured by Clariant), Phenylsulfonat CAL (calcium dodecylbenzenesulfonate, manufactured by Clariant), Geropon CYA/75 (sodium di(2-ethylhexyl) sulfosuccinate, manufactured by Solvay), and Soprophor DSS/7 (polyoxyethylene distyryl phenyl ether sulfuric acid ester ammonium salt, manufactured by Solvay).

Examples of the nonionic surfactant include:
block polymers such as polyoxyethylene polyoxypropylene block copolymers, and block polymers of alkanol, polyethylene oxide, and polypropylene oxide;
synthetic polymers such as vinyl acetate copolymers, polymethacrylic acid, and copolymers of methacrylic acid and methacrylic acid ester;
polyoxyalkylene fatty acid esters such as polyoxyethylene fatty acid esters (e.g., polyoxyethylene stearic acid ester), polyoxypropylene fatty acid esters (e.g., polyoxypropylene stearic acid ester) and polyoxyethylene polyoxypropylene fatty acid ester;
fatty acid esters such as fatty acid esters of polyol, monoglyceride, and phospholipids;
alcohol ethoxylates such as aliphatic alcohol ethoxylates (e.g., tridecyl alcohol ethoxylate, decyl alcohol ethoxylate, isooctyl alcohol ethoxylate, lauryl alcohol ethoxylate, hexadecyl alcohol ethoxylate, and stearyl alcohol ethoxylate), alkylphenol ethoxylates (e.g., nonylphenol ethoxylate, tristyrylphenol ethoxylate, tributylphenol ethoxylate, and octylphenol ethoxylate), arylalkylphenol ethoxylates, and arylphenol ethoxylates (e.g., monobenzylbiphenol alcohol ethoxylate);
alcohol propoxylates such as aliphatic alcohol propoxylate, alkylphenol propoxylate, and arylalkylphenol propoxylate:
polyoxyalkylene vegetable oils such as polyoxyethylene castor oil and polyoxyethylene polyoxypropylene castor oil;
polyoxyalkylene hydrogenated vegetable oils such as polyoxyethylene hydrogenated castor oil;
glycerin fatty acid esters;
glucose esters;
cellulose esters;
polyvinyl alcohol;
sucrose fatty acid esters (e.g., sucrose stearic acid diester);
sorbitan fatty acid esters such as sorbitan laurate, sorbitan stearate, sorbitan oleate and sorbitan trioleate;
polyoxyalkylene sorbitan fatty acid esters such as polyoxyethylene sorbitan laurate, polyoxyethylene sorbitan stearate, polyoxyethylene sorbitan oleate polyoxyethylene sorbitan trioleate, and polyoxyethylene polyoxypropylene sorbitan monolaurate;
fatty acid amine esters such as polyoxyethylene fatty acid amine ester and polyoxypropylene fatty acid amine ester;
polyoxyethylene rosin esters;
amides such as fatty acid alkanolamides (e.g., lauric acid diethanolamide), alkoxylated propylene oxide fatty acid glucamide, polyoxyethylene oleic acid amide, polyoxyethylene stearic acid amide, and polyvinylpyrrolidone; and
amines such as alkoxylated amines (e.g., polyoxyethylene oleylamine, and α,α′-[(9-octadecenylimino)di-2,1-ethanediyl]bis(co-hydroxy)poly(oxyethylene)).

As the nonionic surfactant, a commercially available nonionic surfactant may be used.

Examples of a commercially available nonionic surfactant include, in trade names, Stepflow 26F (polyoxyethylene polyoxypropylene block copolymer, manufactured by Stepan), Toximul 8323 (polyoxyethylene polyoxypropylene block copolymer, manufactured by Stepan), Atlas G5000 (butyl block copolymer, manufactured by Croda), Atlas G5002L (butyl block copolymer, manufactured by Croda), Antarox B/848 (polyoxyethylene polyoxypropylene block copolymer, manufactured by Solvay), Pegnol 24-O (polyoxyethylene fatty acid ester, manufactured by TOHO Chemical Industry), Pegnol 14-S (polyoxyethylene fatty acid ester, manufactured by TOHO Chemical Industry), Pegnol ST-7 (polyoxyethylene alkyl ether, manufactured by TOHO Chemical Industry), ATPLUS245 (polyoxyethylene polyoxypropylene alkyl ether, manufactured by Croda), Synperonic AB6 (polyoxyalkylene alkyl ether, HLB: 12, manufactured by Croda), Brij 03 (polyoxyethylene oleyl ether, HLB: 7, manufactured by Croda), Genapol X060 (polyoxyethylene alkyl ether, manufactured by Clariant), Genapol X150 (polyoxyethylene alkyl ether, manufactured by Clariant), Emulsogen TS200 (polyoxyethylene tristyryl phenyl ether, manufactured by Clariant), Emulsogen TS290 (polyoxyethylene tristyryl phenyl ether, manufactured by Clariant), Emulsogen TS540 (polyoxyethylene tristyryl phenyl ether, manufactured by Clariant), Emulsogen TS600 (polyoxyethylene tristyryl phenyl ether, manufactured by Clariant), Emulsogen EL360 (polyoxyethylene castor oil, manufactured by Clariant), Emulsogen EL400 (polyoxyethylene castor oil, manufactured by Clariant), Emulsogen EL540 (polyoxyethylene castor oil, manufactured by Clariant), Solpol T26 (polyoxyethylene alkyl aryl ether, manufactured by TOHO Chemical Industry), Alkamuls OR/40 (polyoxyethylene castor oil, manufactured by Solvay), Toximul 8240 (polyoxyethylene castor oil, molar number of added EO: 36, manufactured by Stepan), Toximul 8241 (polyoxyethylene castor oil, molar number of added EO: 30, manufactured by Stepan), Toximul 8242 (polyoxyethylene castor oil, molar number of added EO: 40, manufactured by Stepan), NIKKOL HCO-20 (polyoxyethylene hydrogenated castor oil, manufactured by Nikko Chemicals), Geronol TE/250 (mixture of polyoxyethylene castor oil and polyoxyethylene polyoxypropylene monobutyl ether, manufactured by Solvay), NIKKOL MGU (glycerol fatty acid ester, manufactured by Nikko Chemicals), NIKKOL DGS-80 (glycerol fatty acid ester, manufactured by Nikko Chemicals), Newcol 20 (sorbitan laurate, manufactured by Nippon Nyukazai), and Newcol 25 (polyoxyethylene sorbitan laurate, manufactured by Nippon Nyukazai).

With the total amount of the liquid pesticidal composition being taken as 100 mass %, the total content of the ionic surfactant and the nonionic surfactant in the liquid pesticidal composition is preferably 1 mass % or more and 30 mass % or less, more preferably 2 mass % or more and 24 mass % or less, more preferably 3 mass % or more and 27 mass % or less, further preferably 4 mass % or more and 20 mass % or less, further preferably 5 mass % or more and 18 mass % or less, yet further preferably 6 mass % or more and 16 mass % or less, yet further preferably 7 mass % or more and 14 mass % or less, particularly preferably 8 mass % or more and 12 mass % or less.

The total content of the ionic surfactant and the nonionic surfactant relative to the content of the compound (I) is preferably 0.3 times by mass or more and 15 times by mass or less, preferably 0.5 times by mass or more and 12 times by mass or less, more preferably 0.7 times by mass or more and 10 times by mass or less, more preferably 0.8 times by mass or more and 8 times by mass or less, further preferably 1 times by mass or more and 5 times by mass or less.

It is preferable that the liquid pesticidal composition comprise one or more nonionic surfactants and one or more ionic surfactants. The content ratio between the one or more nonionic surfactants and the one or more ionic surfactants is, for example, from 1:0.1 to 1:40 (mass ratio). The content ratio between the one or more nonionic surfactants and the one or more ionic surfactants is, for example, 1:0.2, 1:0.3, 1:0.4, 1:0.5, 1:0.6, 1:0.7, 1:0.8, 1:0.9, 1:1, 1:1.1, 1:1.2, 1:1.3, 1:1.4, 1:1.5, 1:1.6, 1:1.7, 1:1.8, 1:1.9, 1:2, 1:2.1, 1:2.2, 1:2.3, 1:2.4, 1:2.5, 1:2.6, 1:2.7, 1:2.8, 1:2.9, 1:3, 1:3.5, 1:4, 1:4.5, 1:5, 1:6, 1:7, 1:8, 1:9, 1:10, 1:20, or 1:30 (mass ratio).

(d) Water

The water content of the liquid pesticidal composition is 0.04 mass % or more and 3.30 mass % or less. The amount of the water may be 0.05 mass % or more, may be 0.06 mass % or more, may be 0.07 mass % or more, may be 0.08 mass % or more, may be 0.09 mass % or more, may be 0.10 mass % or more, may be 0.12 mass % or more, may be 0.14 mass % or more, may be 0.16 mass % or more, may be 0.18 mass % or more, and may be 0.20 mass % or more. The amount of the water may be 3.20 mass % or less, may be 3.10 mass % or less, may be 3.00 mass % or less, may be 2.90 mass % or less, may be 2.80 mass % or less, may be 2.70 mass % or less, may be 2.60 mass % or less, may be 2.50 mass % or less, and may be 2.40 mass % or less. The water content of the liquid pesticidal composition can be measured according to a method mentioned later in Examples.

The water content of the liquid pesticidal composition is 0.04 mass % or more, whereby storage stability can be improved while the occurrence of precipitation or deposits is prevented during storage in a low-temperature environment. On the other hand, the water content of the liquid pesticidal composition is 3.30 mass % or less, whereby storage stability at low temperatures can also be improved. Also, the water content of the liquid pesticidal composition is 2.80 mass % or less, whereby foaming during shaking or mixing can be prevented. Since the occurrence of precipitation or deposits during storage increases the risk of nozzle blockage at the time of dilution and spraying, it is desirable to prevent this. Since the foaming during shaking or mixing makes accurate weighing difficult in using the liquid pesticidal composition, it is also desirable to prevent this.

The water contained in the liquid pesticidal composition may be, for example, ion-exchange water, tap water and/or groundwater that is added for preparing the liquid pesticidal composition, or may be water contained in a trace amount in each material that is used for preparing the liquid pesticidal composition.

With the total amount of the liquid pesticidal composition being taken as 100 mass %, the total content of the compound (I), the hydrophobic solvent, the surfactant, and the water in the liquid pesticidal composition is preferably 60 mass % or more, more preferably 70 mass % or more, further preferably 75 mass % or more. The total content may be 100 mass %, may be 95 mass % or less, may be 90 mass % or less, and may be 85 mass % or less.

(e) Other Ingredients

The liquid pesticidal composition can optionally contain other ingredients except for those described above.

Examples of other ingredients include pesticidal active ingredients other than the compound (I), solvents other than the hydrophobic solvent, and formulation aids.

With the total amount of the pesticidal active ingredient contained in the liquid pesticidal composition being taken as 100 mass %, the content of the compound (I) in all the pesticidal active ingredients contained in the liquid pesticidal composition may be, for example, 20 mass % or more and 100 mass % or less or 30 mass % or more and 100 mass % or less. The content is, for example, 50 mass % or more and 100 mass % or less, 60 mass % or more and 100 mass % or less, 80 mass % or more and 100 mass % or less, 90 mass % or more and 100 mass % or less or 95 mass % or more and 100 mass % or less.

Examples of the pesticidal active ingredient other than the compound (I) include, but are not particularly limited to, insecticidal active ingredients, fungicidal active ingredients, herbicidal active ingredients, plant growth regulator active ingredients and safener active ingredients. The liquid pesticidal composition can contain one or more pesticidal active ingredients selected from the group consisting of insecticidal active ingredients, fungicidal active ingredients, herbicidal active ingredients, plant growth regulator active ingredients and safener active ingredients as the pesticidal active ingredient other than the compound (I). Each of the insecticidal active ingredient, the fungicidal active ingredient, the herbicidal active ingredient, the plant growth regulator active ingredient and the safener active ingredient may comprise one, two, or more ingredients.

With the total amount of the solvent contained in the liquid pesticidal composition being taken as 100 mass %, the total content of the hydrophobic solvent in all the solvents contained in the liquid pesticidal composition is preferably 70 mass % or more, more preferably 80 mass % or more, further preferably 90 mass % or more, yet further preferably 95 mass % or more, especially preferably 98 mass % or more, particularly preferably 100 mass %, for ensuring that the liquid pesticidal composition has good emulsion stability when mixed with water and that the compound (I) in the liquid pesticidal composition has good chemical stability.

Examples of the formulation aid include antifoaming agents, thickeners, and antiseptics.

Examples of the antifoaming agent include silicone-based antifoaming agents.

When the liquid pesticidal composition contains an antifoaming agent, its content, with the total amount of the liquid pesticidal composition being taken as 100 mass %, is usually 0.001 mass % or more and 1 mass % or less, preferably 0.002 mass % or more and 0.8 mass % or less.

Examples of the thickener include organic solvent-soluble or organic solvent-dispersible thickeners. Examples of the organic solvent-soluble or organic solvent-dispersible thickener include organic clay, organic bentonite, organic montmorillonite, and organically modified castor oil derivatives. When the liquid pesticidal composition contains a thickener, its content, with the total amount of the liquid pesticidal composition being taken as 100 mass %, is usually 0.01 mass % or more and 5 mass % or less, preferably 0.05 mass % or more and 3 mass % or less.

Examples of the antiseptic include isothiazolinone-based antiseptics. When the liquid pesticidal composition contains an antiseptic, its content, with the total amount of the liquid pesticidal composition being taken as 100 mass %, is usually 0.05 mass % or more and 0.5 mass % or less, preferably 0.1 mass % or more and 0.3 mass % or less.

The liquid pesticidal composition of the present invention exerts an excellent herbicidal efficacy, good emulsion stability (i.e. precipitation or phase separation, which may be responsible for uneven spraying, does not occur over an expected time period from dilution to spraying) when mixed with water, good compatibility (i.e. there is no occurrence of precipitates that may cause nozzle blockage) when mixed with a tank-mix partner such as other pesticidal formulations and adjuvants, good pourability from containers, and good chemical stability of the compound (I) in the liquid pesticidal composition when stored in a high-temperature environment.

(f) Production and Use of Liquid Pesticidal Composition

The liquid pesticidal composition can be produced, for example, by mixing the compound (I), the hydrophobic solvent, the surfactant, and optional water, and an optional ingredient to be added, using a stirrer such as Three-one-motor, if necessary, under heating.

The liquid pesticidal composition is applied to control pests or weeds. Specifically, the liquid pesticidal composition is mixed with water to prepare an emulsion, and the emulsion is applied to a plant or soil in which a plant is grown.

Also, the emulsion is prepared by mixing the liquid pesticidal composition with water in usually from 2 to 10000 times, preferably from 10 to 8000 times, more preferably from 15 to 6000 times the volume of the liquid pesticidal composition.

In applying the emulsion, it may be mixed with an adjuvant. Although the type of the adjuvant is not particularly limited, it is desirable to mix an oil-based adjuvant (a mineral oil such as a paraffinic hydrocarbon, a naphthenic hydrocarbon, or an aromatic hydrocarbon, or methylated seed oil in which a vegetable oil (soybean oil or rapeseed oil) is esterified) such as Agri-Dex or MSO at 0.25%, 0.5%, 1%, 2%, 3%, 4%, 5% or 6% (volume/volume) into the spray liquid, or a nonionic adjuvant (polyoxyalkylene alkyl ether, polyoxyalkylene fatty acid ester, alkylaryl alkoxylate, or alkylaryl polyoxyalkylene glycol) such as Induce at 0.05%, 0.1%, 0.25%, or 0.5% (volume/volume) into the spray liquid. Other examples thereof include anionic series (substituted sulfonates) such as Gramin S, cationic series (polyoxyethyleneamine) such as Genamin T 200BM, and organic silicone series such as Silwet L77. Furthermore, a drift control agent such as Intact (polyethylene glycol) may be mixed. The pH or water hardness of the spray liquid is not particularly limited.

### EXAMPLES

In the following, the present invention will be described in further detail with reference to Examples. The scope of the present invention is not limited to these Examples.

<Preparation of Liquid Pesticidal Composition>

### (1) Preparation of Liquid Pesticidal Composition of Production Example 1

The ingredients specified in Table 1 were mixed in the parts by mass specified in Table 1 and stirred into a uniform solution to obtain a mixture. 10 mL of the mixture was placed in a 20 mL glass vessel, to which 2 mg of water was then added and stirred into a uniform solution to obtain a liquid pesticidal composition of Production Example 1. The water content of the liquid pesticidal composition was mass %. The water content was measured by the measurement method described below.

### (2) Preparation of Liquid Pesticidal Composition of Production Example 2

The ingredients specified in Table 1 were mixed in the parts by mass specified in Table 1 and stirred into a uniform solution to obtain a mixture. 10 mL of the mixture was placed in a 20 mL glass vessel, to which 3 mg of water was then added and stirred into a uniform solution to obtain a liquid pesticidal composition of Production Example 2. The water content of the liquid pesticidal composition was mass %. The water content was measured by the measurement method described below.

### (3) Preparation of Liquid Pesticidal Composition of Production Example 3

The ingredients specified in Table 1 were mixed in the parts by mass specified in Table 1 and stirred into a uniform solution to obtain a mixture. 10 mL of the mixture was placed in a 20 mL glass vessel, to which 5 mg of water was then added and stirred into a uniform solution to obtain a liquid pesticidal composition of Production Example 3. The water content of the liquid pesticidal composition was mass %. The water content was measured by the measurement method described below.

### (4) Preparation of Liquid Pesticidal Composition of Production Example 4

The ingredients specified in Table 1 were mixed in the parts by mass specified in Table 1 and stirred into a uniform solution to obtain a mixture. 10 mL of the mixture was placed in a 20 mL glass vessel, to which 6 mg of water was then added and stirred into a uniform solution to obtain a liquid pesticidal composition of Production Example 4. The water content of the liquid pesticidal composition was mass %. The water content was measured by the measurement method described below.

### (5) Preparation of Liquid Pesticidal Composition of Production Example 5

The ingredients specified in Table 1 were mixed in the parts by mass specified in Table 1 and stirred into a uniform solution to obtain a mixture. 10 mL of the mixture was placed in a 20 mL glass vessel, to which 8 mg of water was then added and stirred into a uniform solution to obtain a liquid pesticidal composition of Production Example 5. The water content of the liquid pesticidal composition was mass %. The water content was measured by the measurement method described below.

### (6) Preparation of Liquid Pesticidal Composition of Production Example 6

The ingredients specified in Table 2 were mixed in the parts by mass specified in Table 2 and stirred into a uniform solution to obtain a mixture. 10 mL of the mixture was placed in a 20 mL glass vessel, to which 13 mg of water was then added and stirred into a uniform solution to obtain a liquid pesticidal composition of Production Example 6. The water content of the liquid pesticidal composition was mass %. The water content was measured by the measurement method described below.

### (7) Preparation of Liquid Pesticidal Composition of Production Example 7

The ingredients specified in Table 2 were mixed in the parts by mass specified in Table 2 and stirred into a uniform solution to obtain a mixture. 10 mL of the mixture was placed in a 20 mL glass vessel, to which 17 mg of water was then added and stirred into a uniform solution to obtain a liquid pesticidal composition of Production Example 7. The water content of the liquid pesticidal composition was mass %. The water content was measured by the measurement method described below.

### (8) Preparation of Liquid Pesticidal Composition of Production Example 8

The ingredients specified in Table 2 were mixed in the parts by mass specified in Table 2 and stirred into a uniform solution to obtain a mixture. 10 mL of the mixture was placed in a 20 mL glass vessel, to which 45 mg of water was then added and stirred into a uniform solution to obtain a liquid pesticidal composition of Production Example 8. The water content of the liquid pesticidal composition was 0.48 mass %. The water content was measured by the measurement method described below.

### (9) Preparation of Liquid Pesticidal Composition of Production Example 9

The ingredients specified in Table 2 were mixed in the parts by mass specified in Table 2 and stirred into a uniform solution to obtain a mixture. 10 mL of the mixture was placed in a 20 mL glass vessel, to which 89 mg of water was then added and stirred into a uniform solution to obtain a liquid pesticidal composition of Production Example 9. The water content of the liquid pesticidal composition was mass %. The water content was measured by the measurement method described below.

### (10) Preparation of Liquid Pesticidal Composition of Production Example 10

The ingredients specified in Table 2 were mixed in the parts by mass specified in Table 2 and stirred into a uniform solution to obtain a mixture. 10 mL of the mixture was placed in a 20 mL glass vessel, to which 116 mg of water was then added and stirred into a uniform solution to obtain a liquid pesticidal composition of Production Example 10. The water content of the liquid pesticidal composition was 1.19 mass %. The water content was measured by the measurement method described below.

### (11) Preparation of Liquid Pesticidal Composition of Production Example 11

The ingredients specified in Table 3 were mixed in the parts by mass specified in Table 3 and stirred into a uniform solution to obtain a mixture. 10 mL of the mixture was placed in a 20 mL glass vessel, to which 156 mg of water was then added and stirred into a uniform solution to obtain a liquid pesticidal composition of Production Example 11. The water content of the liquid pesticidal composition was 1.60 mass %. The water content was measured by the measurement method described below.

### (12) Preparation of Liquid Pesticidal Composition of Production Example 12

The ingredients specified in Table 3 were mixed in the parts by mass specified in Table 3 and stirred into a uniform solution to obtain a mixture. 10 mL of the mixture was placed in a 20 mL glass vessel, to which 186 mg of water was then added and stirred into a uniform solution to obtain a liquid pesticidal composition of Production Example 12. The water content of the liquid pesticidal composition was 1.90 mass %. The water content was measured by the measurement method described below.

### (13) Preparation of Liquid Pesticidal Composition of Production Example 13

The ingredients specified in Table 3 were mixed in the parts by mass specified in Table 3 and stirred into a uniform solution to obtain a mixture. 10 mL of the mixture was placed in a 20 mL glass vessel, to which 237 mg of water was then added and stirred into a uniform solution to obtain a liquid pesticidal composition of Production Example 13. The water content of the liquid pesticidal composition was 2.40 mass %. The water content was measured by the measurement method described below.

### (14) Preparation of Liquid Pesticidal Composition of Production Example 14

The ingredients specified in Table 3 were mixed in the parts by mass specified in Table 3 and stirred into a uniform solution to obtain a mixture. 10 mL of the mixture was placed in a 20 mL glass vessel, to which 282 mg of water was then added and stirred into a uniform solution to obtain a liquid pesticidal composition of Production Example 14. The water content of the liquid pesticidal composition was 2.85 mass %. The water content was measured by the measurement method described below.

### (15) Preparation of Liquid Pesticidal Composition of Production Example 15

The ingredients specified in Table 3 were mixed in the parts by mass specified in Table 3 and stirred into a uniform solution to obtain a mixture. 10 mL of the mixture was placed in a 20 mL glass vessel, to which 311 mg of water was then added and stirred into a uniform solution to obtain a liquid pesticidal composition of Production Example 15. The water content of the liquid pesticidal composition was 3.14 mass %. The water content was measured by the measurement method described below.

### (16) Preparation of Liquid Pesticidal Composition of Comparative Production Example 1

The ingredients specified in Table 4 were mixed in the parts by mass specified in Table 4 and stirred into a uniform solution to obtain a liquid pesticidal composition of Comparative Production Example 1. The water content of the liquid pesticidal composition was 0.03 mass %. The water content was measured by the measurement method described below.

### (17) Preparation of Liquid Pesticidal Composition of Comparative Production Example 2

The ingredients specified in Table 4 were mixed in the parts by mass specified in Table 4 and stirred into a uniform solution to obtain a mixture. 10 mL of the mixture was placed in a 20 mL glass vessel, to which 333 mg of water was then added and stirred into a uniform solution to obtain a liquid pesticidal composition of Comparative Production Example 2. The water content of the liquid pesticidal composition was 3.36 mass %. The water content was measured by the measurement method described below.

### (18) Preparation of Liquid Pesticidal Composition of Comparative Production Example 3

The ingredients specified in Table 4 were mixed in the parts by mass specified in Table 4 and stirred into a uniform solution to obtain a mixture. 10 mL of the mixture was placed in a 20 mL glass vessel, to which 390 mg of water was then added and stirred into a uniform solution to obtain a liquid pesticidal composition of Comparative Production Example 3. The water content of the liquid pesticidal composition was 3.93 mass %. The water content was measured by the measurement method described below.

### (19) Preparation of Liquid Pesticidal Composition of Comparative Production Example 4

The ingredients specified in Table 4 were mixed in the parts by mass specified in Table 4 and stirred into a uniform solution to obtain a mixture. 10 mL of the mixture was placed in a 20 mL glass vessel, to which 418 mg of water was then added and stirred into a uniform solution to obtain a liquid pesticidal composition of Comparative Production Example 4. The water content of the liquid pesticidal composition was 4.21 mass %. The water content was measured by the measurement method described below.

<Method for Measuring Water Content of Liquid Pesticidal Composition>

A Karl-Fischer moisture meter of the volumetric titration method (MKS-510N, manufactured by Kyoto Electronics Manufacturing Co., Ltd.) was used, and methanol and HYDRANAL Composite5 (manufactured by Fluka) were used as a solvent and a titration reagent, respectively. The water content of each liquid pesticidal composition was measured. The weight of a sample was about 2 g for the liquid pesticidal compositions of Production Examples 1 to 7 and Comparative Production Example 1, about 1 g for the liquid pesticidal compositions of Production Examples 8 to 12, and about 0.5 g for the liquid pesticidal compositions of Production Examples 13 to 15 and Comparative Production Examples 2 to 4.

<Evaluation of Low-Temperature Stability of Liquid Pesticidal Composition>

mL each of the liquid pesticidal compositions of Production Examples 1 to and Comparative Production Examples 1 to 4 was placed in a 20 mL glass vessel and stored at −20° C. Three days after the storage started, the presence or absence of their respective precipitates was confirmed. As a result, no precipitate was confirmed in the liquid pesticidal compositions of Production Examples 1 to 15. On the other hand, precipitates were confirmed in the liquid pesticidal compositions of Comparative Production Examples 1 to 4.

<Foaming Evaluation of Liquid Pesticidal Composition>

10 mL each of the liquid pesticidal compositions of Production Examples 1 to and Comparative Production Examples 1 to 4 was placed in a 20 mL glass vessel, and the height (mm) of the liquid level of the liquid pesticidal composition in the glass vessel was measured. Then, the glass vessel was covered with the lid, and the operation of inverting the glass vessel 180° in 1 second and putting it back in place in 1 second was repeated 30 times. Subsequently, the glass vessel was left standing for 1 minute. One minute after the still standing started, the foam height (mm) was measured. The foaming volume (%) of the liquid pesticidal composition was calculated according to the following expression.

Foaming volume (%)=(Foam height (mm) 1 minute later)/(Height (mm) of the liquid level of the liquid pesticidal composition)×100

As a result, no foaming was confirmed in the liquid pesticidal compositions of Production Examples 1 to 9 and Comparative Production Example 1. 10% foaming was confirmed in the liquid pesticidal compositions of Production Examples 10 to 13. On the other hand, 25% foaming was confirmed in the liquid pesticidal compositions of Production Examples 14 and 15 and Comparative Production Examples 2 to 4.

TABLE 1

| | | | Production | Production | Production | Production | Production |
|---|---|---|---|---|---|---|---|
| | | | Example 1 | Example 2 | Example 3 | Example 4 | Example 5 |
| Ingredient | Pesticidal | Compound (I) | 5.00 | 5.00 | 5.00 | 5.00 | 5.00 |
| (parts by | active | | | | | | |
| mass) | ingredient | | | | | | |
| | Surfactant | Phenylsulfonat | 5.50 | 5.50 | 5.50 | 5.50 | 5.50 |
| | | CAL | | | | | |
| | | Emulsogen TS 290 | 4.50 | 4.50 | 4.50 | 4.50 | 4.50 |
| | Hydrophobic | Aromatic 200ND | 85.00 | 85.00 | 85.00 | 85.00 | 85.00 |
| | solvent | Fluid | | | | | |

| | | | | | |
|---|---|---|---|---|---|
| Water content (mass %) | 0.05 | 0.07 | 0.08 | 0.09 | 0.11 |
| Low-temperature stability evaluation | Absent | Absent | Absent | Absent | Absent |
| (presence or absence of precipitate) | | | | | |
| Foaming evaluation of formulation | 0% | 0% | 0% | 0% | 0% |
| (foaming volume %) | | | | | |

TABLE 2

| | | | Production | Production | Production | Production | Production |
|---|---|---|---|---|---|---|---|
| | | | Example 6 | Example 7 | Example 8 | Example 9 | Example 10 |
| Ingredient | Pesticidal | Compound (I) | 5.00 | 5.00 | 5.00 | 5.00 | 5.00 |
| (parts by | active | | | | | | |
| mass) | ingredient | | | | | | |
| | Surfactant | Phenylsulfonat | 5.50 | 5.50 | 5.50 | 5.50 | 5.50 |
| | | CAL | | | | | |
| | | Emulsogen TS 290 | 4.50 | 4.50 | 4.50 | 4.50 | 4.50 |
| | Hydrophobic | Aromatic 200ND | 85.00 | 85.00 | 85.00 | 85.00 | 85.00 |
| | solvent | Fluid | | | | | |

| | | | | | |
|---|---|---|---|---|---|
| Water content (mass %) | 0.16 | 0.20 | 0.48 | 0.92 | 1.19 |
| Low-temperature stability evaluation | Absent | Absent | Absent | Absent | Absent |
| (presence or absence of precipitate) | | | | | |
| Foaming evaluation of formulation | 0% | 0% | 0% | 0% | 10% |
| (foaming volume %) | | | | | |

TABLE 3

| | | | Production | Production | Production | Production | Production |
|---|---|---|---|---|---|---|---|
| | | | Example 11 | Example 12 | Example 13 | Example 14 | Example 15 |
| Ingredient | Pesticidal | Compound (I) | 5.00 | 5.00 | 5.00 | 5.00 | 5.00 |
| (parts by | active | | | | | | |
| mass) | ingredient | | | | | | |
| | Surfactant | Phenylsulfonat | 5.50 | 5.50 | 5.50 | 5.50 | 5.50 |
| | | CAL | | | | | |
| | | Emulsogen TS 290 | 4.50 | 4.50 | 4.50 | 4.50 | 4.50 |
| | Hydrophobic | Aromatic 200ND | 85.00 | 85.00 | 85.00 | 85.00 | 85.00 |
| | solvent | Fluid | | | | | |

| | | | | | |
|---|---|---|---|---|---|
| Water content (mass %) | 1.60 | 1.90 | 2.40 | 2.85 | 3.14 |
| Low-temperature stability evaluation | Absent | Absent | Absent | Absent | Absent |
| (presence or absence of precipitate) | | | | | |
| Foaming evaluation of formulation | 10% | 10% | 10% | 25% | 25% |
| (foaming volume %) | | | | | |

TABLE 4

| | | | Comparative | Comparative | Comparative | Comparative |
|---|---|---|---|---|---|---|
| | | | Production | Production | Production | Production |
| | | | Example 1 | Example 2 | Example 3 | Example 4 |
| Ingredient | Pesticidal | Compound (I) | 5.00 | 5.00 | 5.00 | 5.00 |
| (parts by | active | | | | | |
| mass) | ingredient | | | | | |
| | Surfactant | Phenylsulfonat | 5.50 | 5.50 | 5.50 | 5.50 |
| | | CAL | | | | |
| | | Emulsogen TS 290 | 4.50 | 4.50 | 4.50 | 4.50 |
| | Hydrophobic | Aromatic 200ND | 85.00 | 85.00 | 85.00 | 85.00 |
| | solvent | Fluid | | | | |

| | | | | |
|---|---|---|---|---|
| Water content (mass %) | 0.03 | 3.36 | 3.93 | 4.21 |
| Low-temperature stability evaluation | Present | Present | Present | Present |
| (presence or absence of precipitate) | | | | |
| Foaming evaluation of formulation | 0% | 25% | 25% | 25% |
| (foaming volume %) | | | | |

The details of the ingredients specified in Table 1 are as follows.

Phenylsulfonat CAL (mixture of 70% calcium dodecylbenzenesulfonate and 30% iso-butanol, manufactured by Clariant),

Emulsogen TS290 (polyoxyethylene tristyryl phenyl ether, manufactured by Clariant), and

Aromatic 200ND Fluid (containing C10-C13 alkyl naphthalene as its main aromatic hydrocarbon, manufactured by ExxonMobil Chemical).

1. A liquid pesticidal composition comprising
(a) a compound represented by the formula (I): 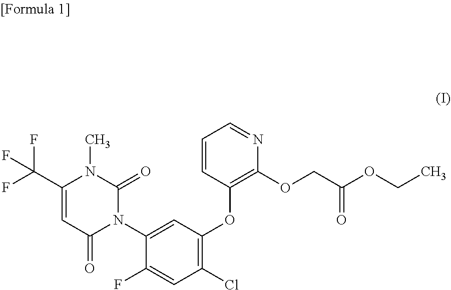 [SMILES: CCOC(=O)COc1ncccc1Oc1cc(-n2c(=O)cc(C(F)(F)F)n(C)c2=O)c(F)cc1Cl]
(b) a solvent having a water solubility at 25° C. of 10 mass % or less,
(c) a surfactant, and
(d) 0.04 mass % or more and 3.30 mass % or less of water.

2. The liquid pesticidal composition according to claim 1, wherein the solvent comprises an aromatic hydrocarbon.

3. The liquid pesticidal composition according to claim 1, wherein the surfactant comprises one or more surfactants selected from the group consisting of anionic surfactants and nonionic surfactants.

4. The liquid pesticidal composition according to claim 1, wherein a content of the water is 0.05 mass % or more and 3.14 mass % or less.

5. The liquid pesticidal composition according to claim 2, wherein the surfactant comprises one or more surfactants selected from the group consisting of anionic surfactants and nonionic surfactants.

6. The liquid pesticidal composition according to claim 2, wherein a content of the water is 0.05 mass % or more and 3.14 mass % or less.

7. The liquid pesticidal composition according to claim 3, wherein a content of the water is 0.05 mass % or more and 3.14 mass % or less.

8. The liquid pesticidal composition according to claim 5, wherein a content of the water is 0.05 mass % or more and 3.14 mass % or less.
